(19) United States
(12) Patent Application Publication
(10) Pub. No.: US 2011/0268282 A1
(43) Pub. Date: Nov. 3, 2011

(54) System and Method for Monitoring Compliance of Sound Levels When Playing Content in Theater Auditoriums

(76) Inventors: Robert Paige, Enoch, UT (US); Christopher H. Theiste, Plymouth, MN (US); William S. Wiatroski, Golden, CO (US)

(21) Appl. No.: 12/769,331

(22) Filed: Apr. 28, 2010

(51) Int. Cl. H04R 29/00

(52) U.S. Cl. 381/56

(57) ABSTRACT

The present invention relates to systems and methods for monitoring compliance with sound volumes in auditoriums. The method includes setting a baseline sound measurement for an audio receiver located in an auditorium. The baseline sound measurement is based on a baseline sample signal broadcast over a baseline period from a sound system, and received by the audio receiver. A sound level standard is defined for content. A live sound measurement is determined over a sampling period of live content broadcast from the sound system. It is then determined if the live sound measurement complies with the sound level standard for content. Notification is provided for non-compliance with the sound level standard for content to a party sourcing the live content.

### BACKGROUND OF THE INVENTION

1. Field of the Invention

The present invention relates to compliance systems, and more specifically to ensuring compliance with sound levels in theater auditoriums.

2. The Relevant Technology

Entertainment industries recognize the fact that customers enjoy viewing movies, and more particularly enjoy viewing movies in theaters. To theater-going patrons, the experience is more than just viewing the movie. It includes the magic of experiencing the movie in a setting that allows, in part, for a theater patron to escape from their ordinary world. The experience begins when the patron leaves for the theater with the intent to see a movie. Upon arrival at the plaza associated with the movie theater, the experience is accentuated by feeding off the enjoyment of others that are conversing, eating, drinking, shopping, or similarly waiting for a movie. The colorful lights of the movie theater act to draw the theater customer inside, and once comfortably seated with food in hand, the customer can begin to escape to a world that only the movie theater experience can provide.

Given that theater patrons are in a joyous mood in anticipation of the movie-going experience and because they are a captive audience, they may also be readily influenced by in-theater advertising and promotions. For instance, movie trailers, advertising spots, public service announcements typically are shown before the main feature, in various combinations. To be most effective, in conjunction with displaying advertising on the larger theater screen, most advertisers would like the sound to be loud enough to focus the audience's attention on the advertising spot.

However, theaters must accommodate various customers, in addition to the advertisers. For instance, theaters want to provide the most enjoyable experience to the movie patron. There are instances when one or more theater patrons would like a particular theater to turn the volume down lower than an advertiser would like. Because, the theater patron is arguably the most vociferous at the time advertising is being played, the theater may choose to accommodate the theater patrons wishes. In those cases, the advertiser may not even be aware that the sound levels have been changed when playing corresponding advertising spots, thereby limiting their effectiveness.

### SUMMARY OF THE INVENTION

The present invention relates to systems and methods for monitoring compliance with sound volumes or audio volume levels in auditoriums. The method includes setting a baseline sound measurement for an audio receiver located in an auditorium. The baseline sound measurement is based on a baseline sample signal broadcast over a baseline period from a sound system, and received by the audio receiver. A sound level standard is defined for content. A live sound measurement is determined over a sampling period of live content broadcast from the sound system. It is then determined if the live sound measurement complies with the sound level standard for content. Notification is provided for non-compliance with the sound level standard for content to a party sourcing the live content.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of an audio monitoring system 100 that is capable of monitoring audio volume levels in a plurality of theaters, in accordance with one embodiment of the present invention.

FIG. 2 is an illustration of a theater monitoring system capable of monitoring for compliance with a standard of sound measurement for content in an auditorium of theater that is a component of the audio monitoring system shown in FIG. 1, in accordance with one embodiment of the present invention.

FIG. 3 is a diagram of an advertising test unit capable of collecting audio volume level measurements in a theater, in accordance with one embodiment of the present invention.

FIG. 4 is a flow diagram illustrating a method for monitoring for compliance with a standard of sound measurement, in accordance with one embodiment of the present invention.

FIG. 5 is an illustration of an auditorium that includes a system that is capable of monitoring for compliance with a standard of sound measurement for content in the auditorium, in accordance with one embodiment of the present invention.

### DETAILED DESCRIPTION OF THE PREFERRED EMBODIMENTS

Reference will now be made in more detail to the preferred embodiments of the present invention, systems and methods for monitoring for compliance with standards of sound measurements in relation to content being broadcast in an auditorium. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention.

Accordingly, embodiments of the present invention provide for real-time notification of compliance with a sound level standard for an auditorium. In addition, other embodiments of the present invention provide the above advantage and are capable of determining when a sound system of an auditorium is malfunctioning, and more particularly determining when the sound system is malfunctioning when specific content is playing. Still other embodiments of the present invention provide the above advantages and are capable of monitoring for compliance with sound level standards on a continuing basis that does not require manual reading of ongoing sound levels in an auditorium, thereby eliminating the costs of having an individual, personally at the site, monitor sound levels. Also, other embodiments of the present invention provide the above advantages, and account for current environmental conditions when monitoring for compliance with sound level standards in an auditorium. Furthermore, other embodiments of the present invention provide the above advantages, and are scalable to accommodate a plurality of auditoriums associated with a plurality of theaters.

Throughout this application, the term “audio volume level” is used generally to refer to sound, and more particularly sound measured at a sound pressure level (SPL). Also, generally the terms “sound” and “audio” are used interchangeably.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. This program or its corresponding hardware implementation is operable for the monitoring of compliance with sound levels in an auditorium. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “defining,” “setting,” “determining,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### System and Method for Cancelling Pending Orders of Financial Articles of Trade

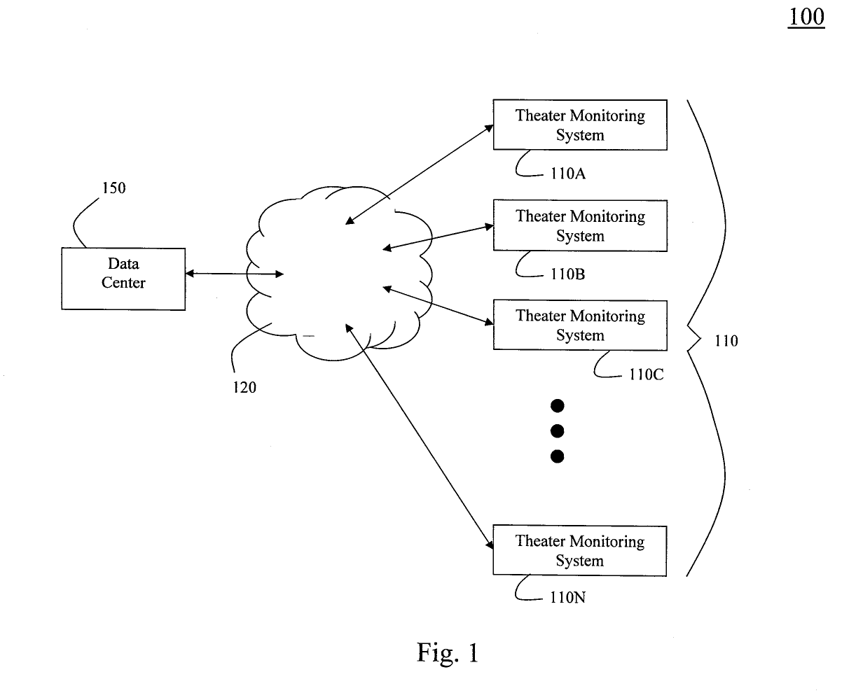

FIG. 1 is an illustration of an audio monitoring system 100 that is capable of monitoring audio volume levels in a plurality of theaters, in accordance with one embodiment of the present invention. More particularly, system 100 includes a plurality of theater monitoring systems 110 that further includes theater monitoring systems 110 A-N, and is associated with the plurality of theaters. Each of the theater monitoring systems 110 A-N is capable of monitoring audio volume levels associated with one or more corresponding auditoriums.

As shown in FIG. 1, the plurality of theater monitoring systems 110 is communicatively coupled to a data center 150. More specifically, data center 150 is able to communicate with each of the plurality of theater monitoring systems 110 through a communication network 120. For instance, network 120 is able to support communication between one or more devices, located throughout the plurality of theater monitoring systems 110, using one or more communication protocols (e.g., hypertext transfer protocol, HTTP, etc.). For example, in one embodiment, the communication network 120 is the internet, but could be any suitable network, such as a wide area network, local area network, telecommunications network, etc.

As shown, the system 100 is scalable to accommodate one or more theater monitoring systems. As such, system 100 can easily be configured to add new theater monitoring systems to monitor audio volume levels in one or more auditoriums. For instance, a new theater coming into system 100 for compliance monitoring of audio volume levels is supported by adding a corresponding theater monitoring system (e.g., monitoring system 110N) to system 100. More importantly, system 100 is able to handle an ever-expanding network of theaters seeking monitoring and compliance monitoring of audio volume level services. Whether it is one, five hundred, or five-thousand, or more, system 100 is able to simultaneously monitor audio volume levels in a plurality of auditoriums in a plurality of theaters across a city, state, nation, region encompassing one or more nations, and across the entire world.

Conversely, system 100 can also be easily configured to scale down the plurality of theaters requesting monitoring services. For instance, when a theater or group of associated theaters wishes to stop monitoring of audio volume levels in auditoriums, corresponding theater monitoring systems need only be removed from system 100. In one case, this is achieved by logically or physically shutting down or switching off the corresponding theater monitoring systems without necessarily physically removing any of the theater monitoring systems. As such, when a theater wishes to come back on-line, system 100 need only turn on the corresponding theater monitoring system so that the data center 150 is able to monitor audio volume levels for that theater.

The data center 150 is configured to provide centralized monitoring of compliance with audio volume levels in the various theaters. As such, data center 150 is able to track compliance and non-compliance of audio volume levels for each of the auditoriums in the plurality of theaters using the plurality of theater monitoring systems 110. With this centralized management, data center 150 is able to provide important information to advertisers in relation to their advertising spots, as an example.

For instance, the advertiser may have one advertising spot playing at numerous theaters and throughout various regions of a country. In addition, the advertiser may have contracted to play that advertising spot at a negotiated volume level or range of volume levels, and would like confirmation that the advertising spot was played at acceptable volume levels. Without dispatching an individual to each of those sites to personally monitor audio volume levels at each of the auditoriums of each of the theaters playing that advertising spot throughout an advertising cycle, embodiments of the present invention, through the use of system 100, are capable of confirming to the advertiser each time an advertising spot was played, when it was played, where it was played, in what sequence it was played leading up to the main feature, and how loudly it was played for a particular advertising spot.

Further, system 100 is capable of providing monitoring of audio volume levels not only for one theater, but simultaneously and for all auditoriums in all theaters throughout a city, state, country, and a region including one or more countries. Previously, this was financially prohibitive and technically difficult to implement, as it required one or more individuals to be present in corresponding auditoriums to monitor audio volume levels throughout the entire monitoring period, whether it be a day, number of days, week, month, etc. On the other hand, system 100 is able to continuously monitor audio volume levels in a plurality of auditoriums of a plurality of theaters for an indefinite period of time. Also, system 100 is able to provide real-time notification of whether a theater is in compliance or out-of-compliance with audio volume levels.

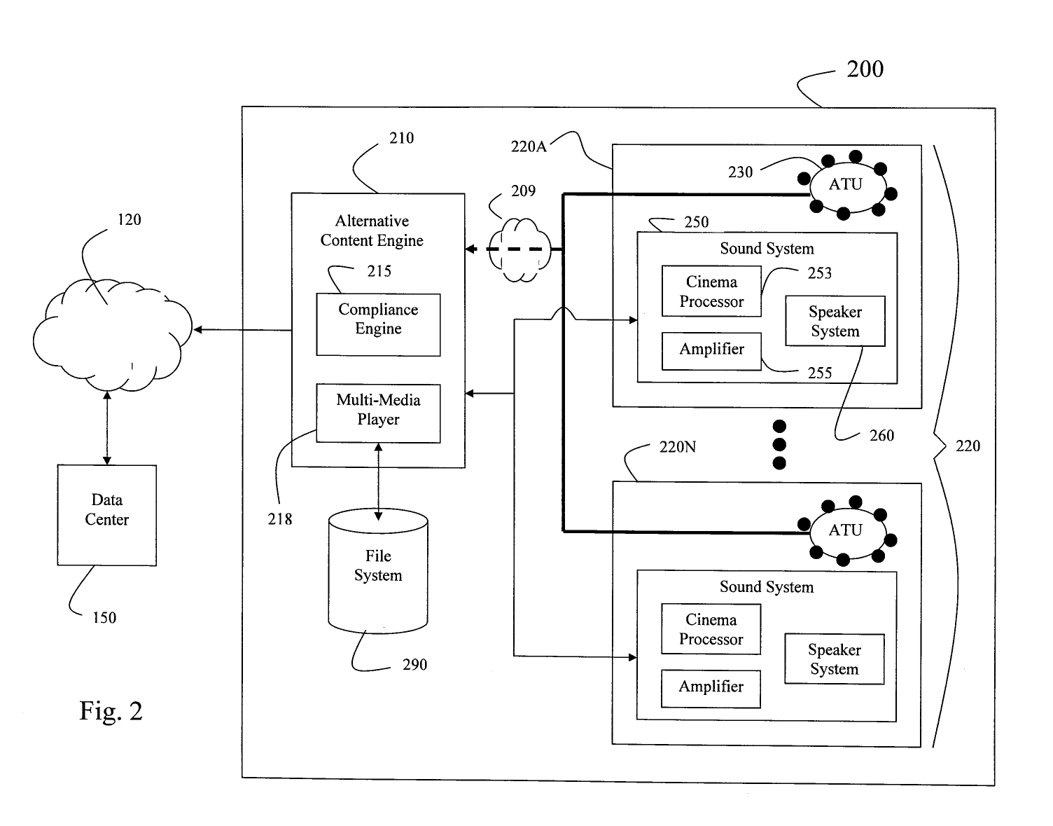

FIG. 2 is an illustration of a theater monitoring system 200 that is a component of the system 100 shown in FIG. 1, in accordance with one embodiment of the present invention. More specifically, theater monitoring system 200 is located at a specific theater and is capable of monitoring audio volume levels and compliance with audio volume levels in one or more auditoriums of the theater. For instance, theater monitoring system 200 is one of the plurality of theater monitoring systems 110, in one embodiment. In other embodiments, theater monitoring system 200 is capable of monitoring auditoriums in one or more theaters.

Theater monitoring system 200 is communicatively coupled with the data center 150 through a communication network 120, as previously described in FIG. 1. While embodiments of the present invention are described where information regarding monitoring of audio volume levels is communicated to a back end data center 150, other embodiments are well suited to theater monitoring system 200 acting independently of the data center 150, in that information is collected, processed, and delivered through notifications locally at the theater.

The theater monitoring system 200 is capable of monitoring audio volume levels in one or more auditoriums in the theater. As shown, a plurality of collection systems 220 is included in system 200. The plurality of collection systems 220 includes collection systems 220 A-N, each of which is capable of broadcasting sound signals and collecting audio volume levels.

In one embodiment, each of the plurality of collection systems 220 is associated with a corresponding auditorium. For instance, one collection system generates sound and collects audio volume levels for a corresponding auditorium. Other embodiments are suitable for monitoring audio volume levels using other configurations of sound monitoring systems, auditoriums, and theaters.

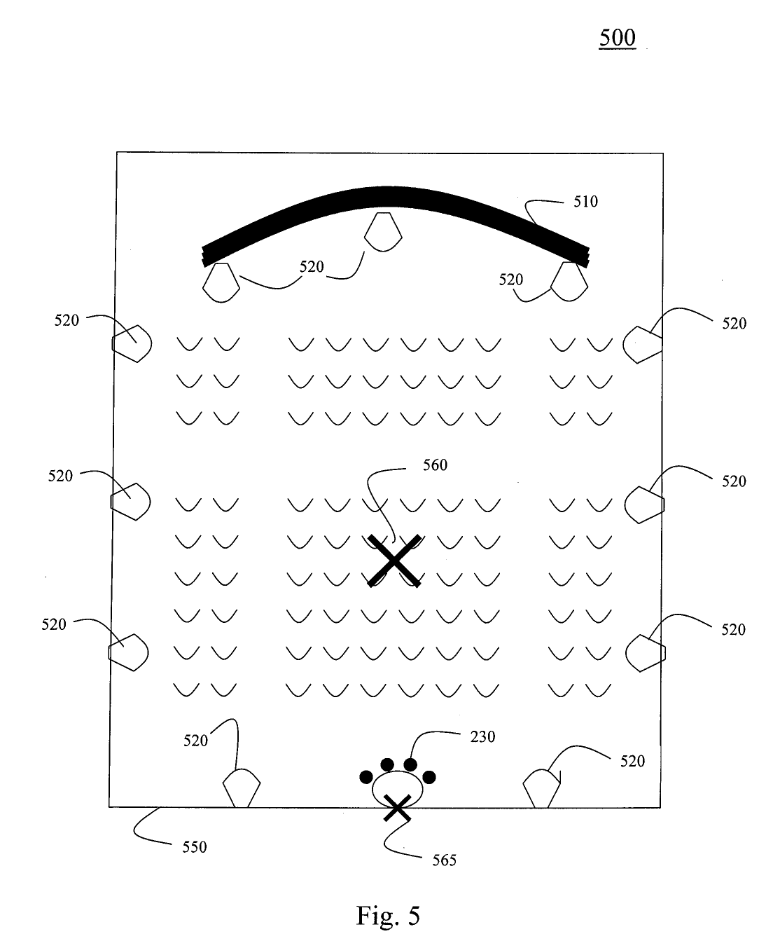

A general description of an auditorium 500 configured to play content (e.g., movies) is shown in FIG. 5. The configuration and layout of auditorium 500 is variable to fit various customer requirements (e.g., floor space, numbers accommodated, screen size, etc.). For instance, auditorium 500 includes a projection screen 510 upon which images are projected. Also a plurality of seats are arranged throughout the auditorium 500 for patrons to sit and view the projection screen 510. Although the following discussion describes the collection of audio volume levels in auditorium 500, it is understood that the theater monitoring system is able to monitor audio volume levels in any type of auditorium or defined space (e.g., indoor, outdoor, etc.).

Returning to FIG. 2, for purposes of illustration only, a discussion of the components and operations of the collection system 220A is representative of the components and operations of each of the plurality of collection systems 220. As an example, collection system 220A is suitably configured to collect audio volume level measurements within auditorium 500, where some or all of the components of collection system 220A are locally situated in auditorium 500. More specifically, collection system 220A includes a sound system 250 and an advertising test unit 230. The sound system 250 includes a cinema processor 253, amplifier 255, and speaker system 260. The advertising test unit 230 is capable of collecting audio measurements broadcasted throughout the auditorium by the sound system 250.

Cinema processor 253 controls the sound system 250 by processing or providing audio content (e.g., sound file) for broadcasting throughout the auditorium. For instance, cinema processor 253 receives the audio content from the multi-media player 218 in the alternative content engine 210, which provides content other than the main feature to be played and broadcast in the auditorium (e.g., advertising spots to include video and audio content, pre-show content, pink noise, etc.). In one embodiment, the multi-media player 218 retrieves a digital sound file from the file system 290, where the digital sound file contains the audio content that is to be broadcast in the auditorium. For instance, the alternative content engine 210 is able to determine when audio and/or video content is scheduled to be played in a particular auditorium. As such, the multi-media player accesses the digital sound file to be played and delivers the digital sound file to the cinema processor 253 for broadcasting. Delivery of the sound file is accomplished through various means, including over various communication networks (e.g., internet or wired connection). In other cases, the cinema processor 253 receives the sound signals (e.g., analog or digital signals) from a video projection system that is playing video on the screen of the auditorium. Still other cases are envisioned for retrieving and receiving audio content by the cinema processor 253.

In another embodiment, the multimedia player 218 and the alternative content engine are distributed systems. That is, the multimedia player 218 is a separate system from the alternative content engine 210. More particularly, the multimedia player 218 receives audio content from the alternative content engine 210 (e.g., pink noise, advertising content, pre-show content, alternative content, etc.), and stores the content for later access. For instance, the multimedia player 218 may play content at the command of the alternative content engine 210. In another instance, the multimedia player 218 may play content at scheduled times. This may be implemented through a theater based point of sale system (POS) and a database controlled by the alternative content engine 210 (e.g., file system 290).

In one embodiment, alternative content engine 210 provides and determines when pre-show content is to be played in an auditorium. For instance, audio and/or video pre-show content includes third party advertising spots, theater instructions, public service announcements, and other content that are packaged together into a pre-show and typically shown before the movie trailers and the main feature. The pre-show content is supplied, such as through the data center 150, by a third party vendor or source that controls the alternative content engine 210. This content may be stored in file system 290 and retrieved by the multi-media player 218 as instructed by the alternative content engine 210 at the appropriate time for delivery, such as delivery of audio content to the sound system 250. Also, in another embodiment alternative content engine 210 is able to supply signals (e.g., pink noise) used for determining a baseline or for calibrating the sound monitoring system 220A, as will be further described below.

As shown in FIG. 2, audio content is delivered by cinema processor 253 to the amplifier 255 to increase the signal power of the audio signal. The amplified audio signal of the audio content is then broadcast over the speaker system 260 of the corresponding auditorium. The speaker system 260 includes one or more speakers strategically arranged to broadcast sound throughout the auditorium. For instance, speaker system 260 is shown in auditorium 500 to include one or more speakers 520 arranged throughout an auditorium 500. For instance, speakers 520 are arranged along the two side walls, along the back wall, and include three stage left/center/right stage speakers. Also, a subwoofer may be included as a stage speaker, in some configurations. In certain configurations the audio signal from the cinema processor 253 needs amplification in order for the speaker system 260 to adequately broadcast the audio content. As such, in one embodiment, the theater monitoring system 200 is capable of monitoring audio volumes in auditorium 500, but is also able to determine whether the amplifier 255 is operating properly.

Collection system 220A also includes an advertising test unit (ATU) 230, which is configured to receive the audio content being broadcast in auditorium 500. For instance, ATU 230 includes one or more microphones for receiving the audio content, and more specifically is used to sample audio volume levels broadcasted throughout the auditorium. The one or more microphones is configured to pick up audio omni-directionally, or from one or more directions, in embodiments.

Referring now to FIG. 5, the ATU 230 may be located at any point within the space defining the auditorium 500. For instance, as shown in FIG. 5, ATU 230 is located at the rear of auditorium 500 mounted on the back wall 550 at point 565, and ideally in a fixed location. In one implementation, ATU 230 is located near the projection booth located behind the back wall 550 of the theater 500. The height off the floor of the auditorium 500 may also vary, for instance situated at a height beyond the reach of patrons to the auditorium 500. Ideally, ATU 230 is situated in auditorium 500 at a location that detects sound from many directions.

As shown in FIG. 2, the audio content collected by the ATU 230 is then delivered to the compliance engine 215 in the alternative content engine 210. Compliance engine 215 is capable of determining whether audio volume levels of corresponding content, as broadcasted by the sound system 250 is in compliance with predefined sound standards. These sound standards are defined for content in general, or for specific content.

In the present embodiment, audio content collected by each of the ATUs in the plurality of collection systems 200 is delivered to a centralized compliance engine for further processing in order to monitor audio volume levels in auditoriums and determine if those audio volume levels are in compliance with predefined standards. Delivery to the alternative content engine 210 may be achieved through any suitable means. For instance, data may be delivered to alternative content engine over a wired network, a wireless network 209, or over any other type of network using corresponding communication protocols. Still other embodiments in various configurations are well suited to performing further processing of the audio content within each of the collection systems, wherein the ATU 230, or a dedicated compliance engine in the collection system 220A, is capable of performing further processing and analysis of the collected information.

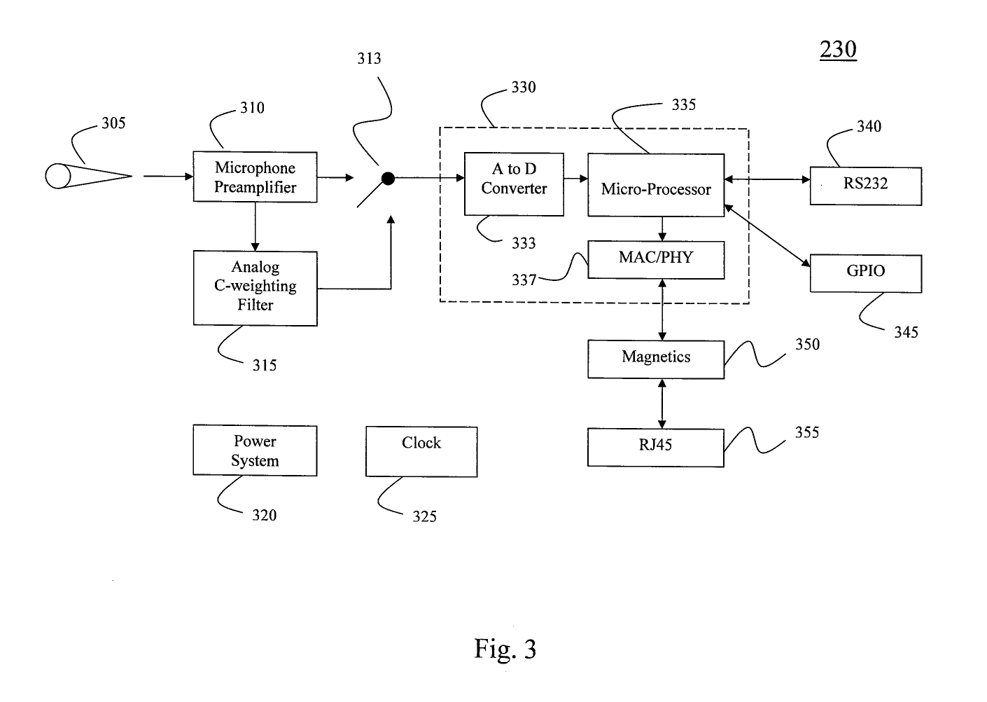

FIG. 3 is a more detailed diagram of exemplary components for the ATU 230, shown in FIG. 2, that is capable of collecting audio volume level measurements in a theater, in accordance with one embodiment of the present invention. The configuration of the ATU 230 as shown is intended to illustrate its functionality in collecting audio volume level measurements. It is understood that other configurations of components for ATU 230 are possible, such as configurations that perform analog filtering, digital filtering, or no filtering. The ATU 230 is included within one of the plurality of collection systems 220 of FIG. 2.

ATU 230 is capable of measuring or sampling audio volume levels in a corresponding auditorium. For instance, in one embodiment, the ATU 230 is configured to measure audio volume levels from approximately 60 dB (decibel) to 110 dB, while other embodiments are suited to taking measurements over different ranges. An acceptable error range, or tolerance, is +/−2 dB, in one implementation, but other implementations could include a higher or lower error range.

ATU 230 is configured to measure audio in accordance with standard audio measurement techniques, in embodiments of the present invention. For instance, ATU 230 is configured to measure audio using any combination of sound pressure level standards associated with the International Electrotechnical Commission (IEC), such as those defined in the IEC 61672-1 standard and its derivatives, or any other international standard, that govern SPL meters. As examples, the ATU may be configured to perform A-weighting, C-weighting, slow response time measurement, fast response time measurement, long-term equivalent level (LEQ) measurements, etc., or any combination of the above.

As shown, ATU 230 includes a microphone 305 that is configured to receive or detect audio signals or audio content. The audio content detected includes a baseline sample signal used for testing (e.g., pink noise), general content, and specific content, such as advertising spots. In one embodiment, the microphone is omni-directional, in that sound from more than one direction is capable of being received. Microphone 305 is pointed to the center of the projection screen 510 in one implementation to best receive audio signals. Microphone 305 may include one or more microphones depending on the configuration selected.

A microphone preamplifier 310 amplifies the audio signal detected by the microphone 305. For instance, a fixed or programmable gain will amplify the received audio signal to a level that is appropriate for further processing by other components of the ATU 230, such as for analog-to-digital conversion, C-weighting, etc.

The amplified signal is optionally passed through an analog C-weighting filter 315. For instance, filter 315 is able to emphasize particular frequencies of sound. A C-weighting filter is used to approximate a human ear at very high sound levels, such as those experienced in an auditorium showing movies. Measurements taken with C-weighting are indicated with the following symbology, dB(C), in this application. Other embodiments are well suited to other types of filters (e.g., A-weighting filter, etc.).

In one embodiment, the analog C-weighting filter 315 is implemented through an active filter, which includes operational amplifiers, resistors, and capacitors. Bypassing the analog C-weighting filter is accomplished using a hardwired jumper, in one implementation, as shown by switch 313.

In still another embodiment, C-weighting is performed digitally after the audio signal has been converted to a digital signal. For instance, microcontroller 330 includes a digital C-weighting filter. This is facilitated by switch 313 so that the audio signal may be delivered from the microphone preamplifier 310, instead of from the analog C-weighting filter 315. In addition, switch 313 is implemented in cases where neither analog nor digital C-weighting is performed.

As shown in FIG. 3, the received audio signal is then delivered to microcontroller 330. For instance, microcontroller includes an analog to digital converter 333 for converting the received audio signal into digital form. After conversion, the audio signal is then delivered to the micro-processor 335 that samples the received and amplified audio signal, and performs additional signal processing, as will be described below.

In one embodiment, the received audio signal, amplified and optionally filtered with C-weighting, is sampled at a sample rate of at least 44.1 KHz. Other sampling frequencies are supported in embodiments. Thereafter, the sampled audio information is placed into a buffer for access for additional processing. In one case, to have a fixed sample rate, the audio sampling process is run in the interrupt service routine.

In another embodiment, the microcontroller 330, and more specifically, micro-processor 335, is capable of computing the average audio volume level over a period, and computing the peak audio volume level. For instance, the microcontroller 330 is capable of accessing and reading the sampled data from the buffer.

In one implementation, an average is computed for a sampling period, and presented as an audio measurement. In one implementation, the audio volume level measurement is a slow response time measurement that takes an average of the sound energy over a one second sampling period, or any suitable interval. Other implementations are well suited to taking fast response time measurements taking averages of sound energy over periods much less than one-second. To compute the average, a root mean square operation is performed to average the audio volume level over a sampling period (e.g., 1 second), in one embodiment. As such, an audio volume level measurement, as an average, is computed and transmitted every second in dB for sound pressure level (SPL).

In one embodiment, the reporting period is every 15 seconds, but could be over any interval. More particularly, microcontroller 330 averages the sampled one-second audio level measurements to compute an average audio level measurement over a 15 second reporting period. Then, microcontroller 330 averages the sampled one-second audio level measurements over the next 15 second reporting period to compute another average audio level measurement. In another embodiment, the microcontroller 330 is able to provide a rolling average of the previous fifteen one-second measurements. This may be computed and delivered every second, in one implementation. For example, from time zero at second 20, the fifteen second average of the one second measurements from second 5 to second 20 is provided. At second 21, the average of the one second measurement from second 6 to second 21 is provided, and so on.

In still another embodiment, the microcontroller 330, and more specifically, micro-processor 335, is capable of computing the peak audio volume level. In one implementation, a peak audio level measurement is provided once every reporting period (e.g., every 15 seconds). As such, the peak audio level measurement is the greatest of the sampled one-second audio level measurements over the last period (e.g., 15 seconds). The next peak audio level measurement is the greatest of the sampled one-second audio level measurements over the next period. In another implementation, a peak measurement is provided at rolling intervals (e.g., 1 second). The peak audio level measurement is the largest of the previous 15 sampled one-second audio level measurements, calculated and described above. As such, the peak audio level measurement represents the average energy over one-second, for the one-second sampling period in which the largest average audio energy was present over the last period (e.g., the last 15 one-second blocks).

The communications interface in microcontroller 330 includes MAC/PHY, transformer magnetics 350, and RJ45 interfaces that make up the standard IEEE 802.3 Ethernet Interface to communicate over a network, in embodiments of the invention. Other types of interfaces are envisioned.

Also, a general purpose input output (GPIO) interface 345 is optionally provided to provide for configuration changes, a factory default reset jumper, and an operational status light emitting diode (LED) (e.g., power and status). That is, the GPIO interface 345 can be used to be signaled for purposes of controlling the ATU 230 (e.g., hardware or software sampling or control). For instance, network and serial configurations may be updated. Also, a calibration command initiates a calibration mode to process the calibration sequence. The GPIO interface 345 may provide polling of the reset jumper. If the reset signal is detected for at least 3 seconds, in one implementation, a reset resets to the configuration back to default values. Also, an LED may indicate power and status conditions. In one case, an LED flashing once every 5 seconds may indicate a status of proper ATU operation.

An RS232 pinout is provided as an additional communications interface, in one implementation. For instance, the RS232 may provide a universal asynchronous receiver transmitter (UART) interface. Also, a character echo function may be implemented through the RS232 interface. In addition, the RS232 port can be used to convert network traffic from an Ethernet port so that the traffic can be sent to and received from a RS232 serial connected device (e.g., when controlling the attached RS232 device). In addition, the RS232 port can also send out audio level measurement data. Further, the RS232 port can be used to configure the ATU 230 (e.g., hardware or software).

In embodiments, the following network configurations are presented for purposes of illustration, but is understood that other protocols may be used for facilitating communication between devices. For instance, the network stack includes transmission control protocol/internet protocol (TCP/IP), user datagram protocol/internet protocol (UDP/IP), address resolution protocol (ARP), and internet control message protocol (ICMP) protocols to perform the necessary network operations. The ICMP protocol is used to support “ping” signaling. TCP, supports Telnet protocol for transmitting the audio measurements to the host unit (e.g., alternative content engine 210, etc.), as well as for configuring the device. For instance, a wired or wireless connection may be made to a Telnet server over a communication port communicating with a network (e.g., internet) to transfer the peak and average audio volume level calculations to the alternative content engine 210. UDP/IP supports the TFTP protocol for firmware updates. In addition, communication may be implemented using the open source uIP TCP/IP network stack.

Power system 320 is shown to provide power to the ATU 230. In one implementation, the power system 320 converts external 9-12 VDC into appropriate voltages for both analog and digital circuits present in the ATU 230. Also, clock 325 is shown providing clocking for the digital circuits, such as the MAC/PHY interface. In one implementation, clocking is provided at 50 MHz.

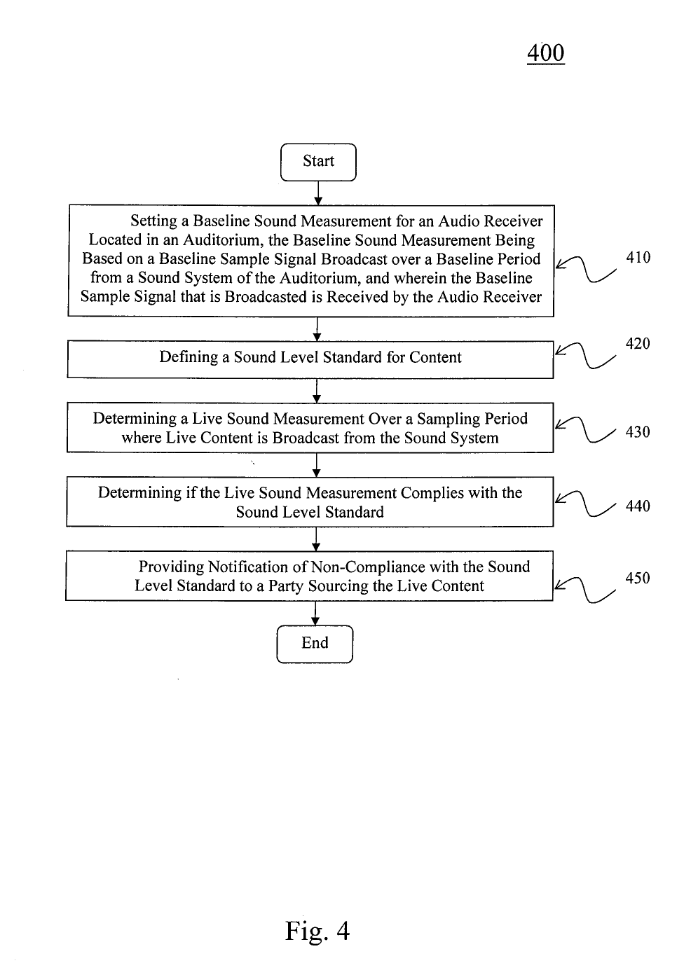

FIG. 4 is a flow diagram 400 illustrating a method of monitoring audio volume levels in one or more auditoriums, in accordance with one embodiment of the present invention. More specifically, flow diagram 400 illustrates a method for monitoring compliance of audio volume levels with predefined standards.

At 410, a baseline sound measurement, that establishes a baseline, is set for an audio receiver (e.g., ATU) located in an auditorium. The baseline sound measurement is based on a baseline sample signal that is broadcast over a baseline period over a sound system of the auditorium and received by the audio receiver in order to calibrate the audio receiver, in one embodiment.

For instance, the calibration procedure is used to calibrate the audio receiver to the sound system in the auditorium. As such, when calibrating the audio receiver, the baseline sample signal is broadcast over the sound system. In one case, the baseline sample signal is pink noise, but other types of signals are well suited for purposes of calibration. While the baseline sample signal is broadcasted, a measurement of sound is taken at a point 560 in the auditorium that is representative of all points in the auditorium. In one case, this point 560 is where the least interference of sound signals is presented, or at an optimum point for receiving audio content. Typically, this may be taken using a portable sound meter that reads sound pressure levels at a point two-thirds back from the projection screen towards the back wall 550, and along a middle line between the two sides of the auditorium, assuming the auditorium is generally rectangularly shaped. The audio level outputted by the sound system is adjusted until the portable sound meter reads a certain value, the desired calibration reference point (e.g., 75 dB(C) with C-weighting) (referred to as C0). As such, a request to the sound system to play audio content at 75 dB will be broadcasted at 75 dB.

The actual sound level measured at the ATU may be different from the portable sound meter, because the ATU is located at a different point 565, on the back wall 550, than where the calibration reference point was measured at point 560, at an optimum point for receiving audio content. As such, calibration of the ATU 230 is performed so that the measured sound at the ATU 230 is representative of sound taken at the center point 560. In other words, the calibration procedure is performed to calibrate the ATU reading to the reading taken by the portable sound meter (C0).

During the calibration procedure, an average audio volume level measurement is taken from the ATU 230 while the baseline sample signal is broadcasted over the sound system and measured at the center point 560 to be 75 dB(C). This average value is denoted as C1. As an example, the average value measured as C1 equals 72 dB(C), with C-weighting if optionally available.

As a result, an offset may be determined that calibrates the ATU 230 to the sound measured at the center point 560 to be 75 dB(C), as C0, the calibration reference point. For instance, in one embodiment, this offset is C0−C1. Thereafter, any measurement (X0) made by the ATU may be adjusted by the offset to achieve an adjusted value Y0, where X0 is the audio volume level measured by the ATU without calibration (averaged or otherwise), as follows:

Y0=X0+(C0−C1) (1)

In the example provided above where C1 is 72 dB(C), then the offset would be 3 dB(C), or 75 dB(C)−72 dB(C), such that any measurement of X0 is adjusted by 3 dBC to achieve the desired value. As such, Y0=X0+3 dB(C), and the value of Y0 is delivered over the network, such as to the alternative content engine 210 for further analysis.

Returning to FIG. 4, at 420, a sound level standard is defined for content. For instance, the standard is defined for content in general. In another instance, the standard is defined for specific content, such as an advertising spot, or any alternative content. In both of these cases, the standard is used to verify compliance of the audio volume levels broadcasted in a corresponding auditorium, either with an audience or without. Any number of interested parties may define a sound level standard, such as the theater, the source of the pre-show, the source of the advertising spots, and the theater chain to name a few.

As examples, one sound level standard is a range of acceptable sound measurements of audio volume levels. In one case, the range is defined in relation to an average sound level of the baseline sound measurement. For instance, if the baseline sound measurement is defined at 75 dB(C), then an acceptable range could be +/−5 dB(C), or 70 dB(C) to 80 dB(C) within which compared measurements should fall. In another example the sound level standard is a minimum value, where compared measurements should exceed the sound level standard. In another example, the sound level standard is a maximum value, where compared measurements should not exceed the sound level standard. Another sound level standard is a defined peak audio volume level, where compared measurements should fall within a given range of the peak.

In one embodiment, the sound level standard is defined for general content. For example, the sound level standard may be used to verify that the sound system in a corresponding auditorium is operating, such as whether the sound system (e.g., amplifier 255) has been turned on, or whether the system is malfunctioning. In another example, the sound level standard may also be used to monitor audio content broadcasted generally within the corresponding auditorium to determine whether it is being broadcasted at acceptable levels. For instance, the sound level standard is defined internally to provide the best experience for the patron viewing the alternative content (e.g., advertising spot), or other content, such as cinema trailers and the main feature (e.g., movie). Also, the sound level standard may be defined internally to provide the most effective delivery for the content, on behalf of the sources of the content (e.g., sources of advertising being broadcasted in the auditorium, the theater playing cinema trailers and the main feature, etc.). As an example, the sound level standard may be set at 75 dB(C) for general content, such that content in general should be broadcasted throughout a corresponding auditorium at 75 dB(C).

In another embodiment, the sound level standard is defined by contract. The sound level standard may be applicable to one or both of general content or specific content. As an example, an advertiser as a source of advertising content may have one or more advertising spots being delivered and broadcasted in one or more auditoriums. As such, the advertiser may negotiate that the audio volume level should reach a particular value to have the most effect on viewers. For instance, the defined standard may be 75 dB(C) for the advertising content. Correspondingly, a second sound level standard may be applicable to other specific audio content, or to audio content in general. As such, in one pre-show, there may be one or more sound level standards applicable to one or more implementations of audio content.

One contracted sound level standard may be applicable to all the advertising content attributed to the source (e.g., advertiser), such that the source has contracted that all advertising content be in compliance with the sound level standard (e.g., 75 dB(C)). In another example, the contracted sound level standard is applicable to specific audio content provided by the source, such as a specific advertising spot. It may be case that the advertiser negotiates that the specific advertising spot be broadcast at 80 dB(C). In still another example, the contracted sound level standard is applicable to audio content provided or managed by the theater, such as the cinema trailers or main feature.

In still another instance, the standard is defined for the baseline sample signal, and is used to verify the audio calibration of the audio receiver (e.g., ATU). For instance, the defined standard may be 75 dB(C), to be in alignment with the calibration reference point, previously described, and is used to verify the calibration of the ATU.

At 430, a live sound measurement is determined over a sample period, where live audio content is broadcast from a sound system of the auditorium. That is, audio volume levels are measured while content is being broadcast over the sound system. In one implementation, the ATU measures the audio volume levels. This may occur when audio content, in general, is being broadcast (e.g., pre-show content, cinema trailers, main feature, etc.), or when specific audio content (e.g., a particular advertising spot) is being broadcast, or when the baseline sample signal (e.g., pink noise) is being broadcasted to verify the calibration of the ATU.

At 440, it is determined if the live sound measurement complies with the sound level standard for content. In particular, the live sound measurement is compared to the sound level standard to determine if the live sound measurement is in compliance. In one implementation, the sound level standard is an audio volume level that is an average of volume levels over a period. As examples, the sound level standard is a minimum to be exceeded, a maximum not to be exceeded, or a range of which the live sound measurement must fall within. In another implementation, the sound level standard is a peak audio volume level over a period, as previously described. In both of these implementations, an acceptable error (e.g., +/−2 dB(C)) may also be applied to the sound level standard within which measured volume levels are still in compliance with the sound level standard.

In one embodiment, general audio content is measured and compared. For instance, general audio content includes any type of content that is being broadcasted over the sound system of a corresponding auditorium. The content may include an advertising spot, a theater promotion or message, public service announcements, cinema trailers, main feature such as the movie, etc. The content may also include alternative content that is the main feature, such as a live performance of a world renowned opera troupe, or other live events, that is simulcast into the auditorium. As described previously, many parties may be interested for various reasons in determining whether the audio volume levels are appropriate or in compliance, to include the theater, source of pre-show content, advertisers, advocates for movie patrons, etc.

For instance, a live sound measurement may be taken and compared to a sound level standard to determine if the sound system is operating properly. The live sound measurement may be reading too low, indicating that the sound system may have manually been turned down (e.g., using the master fader control), come out of calibration, has not been turned on, or is malfunctioning. In addition, a low measurement may indicate that the sound file may have an error, especially when the corresponding advertising spot is broadcasting low, but other content played in that auditorium is in compliance with the sound level standard. In another case, a live sound measurement is taken and compared to a sound level standard to determine if the content meets contractual standards, as in the case where an advertiser wants to ensure that corresponding advertising is being broadcasted at a volume level in compliance with the standard (e.g., minimum, range, maximum, etc.). In addition, determining that a live sound measurement is in compliance also provides further confirmation to the advertiser that their advertising spots have been played, or at the very least, audio from the advertising spots have been broadcasted for a corresponding auditorium. As such, one embodiment may be implemented as an auditing service ensuring that that advertising is being played at the contracted for times, frequency, and placement within the pre-show (e.g., order in relation to the main feature).

In another embodiment, specific audio content is measured and compared. For instance, the audio volume levels in an auditorium are measured when a particular advertising spot, or other content (e.g., syndicated broadcast of live opera performance) is being broadcasted. The live sound measurement of an audio volume level is compared to a sound level standard to determine if the audio content being broadcasted is in compliance with the negotiated sound level standard. In this case, the sound level standard is defined in relation to the specific audio content that will be played live. As such, when the live sound measurement is in compliance, the source of the content is given confirmation that their audio content is being broadcast at negotiated levels. Conversely, when the live sound measurement is not in compliance, then further action may be taken to ensure compliance, as will be further described below.

In one embodiment, the specific audio content includes the baseline sample signal (e.g., pink noise) that was used to calibrate the ATU. Measurement and comparison of the baseline sample signal used as live content is performed to verify calibration of the ATU, and in another instance to verify that the sound system is operating properly. More specifically, the baseline sample signal is re-broadcasted by the sound system in a corresponding auditorium during a period in which interference by extraneous noise is minimized, such as during an off-period in which the auditorium is empty of individuals. Ideally, measurement is made at the beginning of the scheduling day, before any main features will be shown. This is an attempt to replicate the environment during which the ATU was originally calibrated. As such, by rebroadcasting the baseline sample signal at calibrated levels, the ATU should measure the same audio volume level that is the calibration reference point, within tolerance. In this manner, calibration of the ATU is verified. Also, if the ATU is not measuring to the calibration reference point, within tolerance, then this may indicate that the ATU is out of calibration, or it may indicate that the sound system is malfunctioning or not powered on (e.g., amplifier has not been turned on).

At 450, results indicating whether the live sound measurement meets compliance with the sound level standard is provided to interested parties. Notification may be provided immediately, with daily reporting messages, or at any other conceivable time. For instance, notification or reporting of non-compliance with the sound level standard for content is delivered to a party sourcing the live audio content. As an example, referring now to FIG. 2, the compliance engine 215 delivers notification of non-compliance back to the command center or data center 150, where the data center 150 is associated with a party providing and controlling the alternative content being broadcasted at the corresponding auditorium (e.g., auditorium 500), in one embodiment. In one implementation, notification is provided using simple network management protocol SNMP traps (e.g., alarms), but could be provided using any type of reporting method. In one case, the party providing and controlling the alternative content is the source of the pre-show content that packages one or more items of content (e.g., advertising spots) into the pre-show.

In one embodiment, notification is provided based on certain criteria. For instance, notification is provided after multiple reports of non-compliance with a sound level standard is received over a period of days. In this manner, further assurances are made to ensure the validity of the non-compliance notification, reporting, or alarm.

Importantly, notification is sent primarily to a third party remote from the theater and corresponding auditorium, in one embodiment. That is, the third party is not the theater that owns and maintains the sound system in the corresponding auditorium, and as such, the third party does not have master control over the volume of the sound system. More specifically, the third party does not have control over the master fader which provides and overriding control of the volume of the sound system. Instead, notification is delivered over a communication network (e.g., internet) to a third party that is capable of monitoring a plurality of audio volume levels in a plurality of auditoriums. In one embodiment, the third party is the packaging source of the pre-show content that packages one or more items (e.g., advertising spots, promotional spots, public service announcements, etc.) for play in the theater before the main feature. In this manner, by monitoring audio volume levels the packaging source of the pre-show content is able to verify that the pre-show content is being played in corresponding auditoriums. It is important to note that the third party may package alternative content to be played as a main feature (e.g., live sporting event, opera show, etc.) at a certain sound level standard. In another embodiment, the third party is an advertiser associated with an advertising spot from which audio volume levels are measured in a corresponding auditorium that this playing the advertising spot. Notification of non-compliance and other monitoring information may be provided directly to the advertiser. In another implementation, notification of non-compliance and other monitoring information may be passed to the advertiser by the packaging source of the pre-show content.

Once the data center, or party sourcing the audio content, is notified, additional steps may be taken. For instance, in one implementation contact is made with the theater to provide notification that the sound system is malfunctioning. Various means for contacting are envisioned, including sending notification messages through a communication network, making person-to-person contact, etc. In that way, the theater is able to check the sound system in the corresponding auditorium to check for faulty use (e.g., sound system is turned off) or failing devices. In another implementation, control signals are sent back to the sound system of the corresponding auditorium to vary the volume control to bring back audio volume levels back into compliance. For instance, an instruction may be to increase or decrease the volume output incrementally until the measurement of the audio volume at the ATU is in compliance with the corresponding sound level standard.

In another embodiment, the information obtained through monitoring is stored. In one case, the information is stored locally at the theater in conjunction with the alternative content engine. For instance, the information may be stored in file system 290. In another case, the information is stored remotely by the back end data center 150. For instance, the information may be directly stored by the data center, or the locally stored information may be later accessed by the data center for further processing and storing.

Also, another embodiment of the present invention accounts for current environmental conditions when monitoring for compliance with sound level standards in an auditorium. More particularly, once the baseline sound measurement is set to calibrate the audio receiver (e.g., ATU) in the auditorium, and the sound level standard is defined, the sound level standard is customized to account for the current environmental conditions in the auditorium. For example, the auditorium may be more humid one day when compared to another day, such as the day during which the ATU was calibrated. This difference in humidity will affect sound measurements by the ATU. The customized sound level standard may be defined once a day to account for current conditions.

As an example of customizing a sound level standard, the baseline sound measurement is set to determine the offset for the ATU during calibration. As such, the ATU is calibrated to the calibration reference point using an offset, and all measurements by the ATU are similarly offset. The sound level standard is defined for general content or specific content. However, during customization, the baseline sound measurement is again re-measured by broadcasting the baseline sample signal (e.g., pink noise) during a period when extraneous noise is minimized (e.g., when the auditorium is empty). Instead of verifying the calibration, as previously described, the procedure now is implemented to customize a sound level standard. The procedure assumes that the ATU and the sound system are still in calibration with each other. As such, by broadcasting the baseline sample signal at the requested calibration reference point, a new measurement of the audio volume level is taken by the ATU. A customization offset may be determined by comparing the new measurement to the calibration reference point. This offset is applied to the sound level standard to obtain the customized sound level standard. Thereafter, any audio volume level measurements taken by the ATU in the corresponding auditorium are compared not to the sound level standard, but to the customized sound level standard.

A system and method for monitoring audio volume levels in a plurality of auditoriums to determine compliance with sound level standards is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

We claim:

1. A method of compliance, comprising:
setting a baseline sound measurement for an audio receiver located in an auditorium, said baseline sound measurement being based on a baseline sample signal broadcast over a baseline period from a sound system of said auditorium, and wherein said baseline sample signal that is broadcasted is received by said audio receiver;
defining a sound level standard for content;
determining a live sound measurement over a sampling period of live content broadcast from said sound system and received by said audio receiver;
determining if said live sound measurement complies with said sound level standard for content; and
providing notification of non-compliance with said sound level standard for content to a party sourcing said live content.

2. The method of claim 1, wherein said setting a baseline sound measurement comprises:
setting a baseline sound measurement comprising an average sound level.

3. The method of claim 2, wherein said defining a sound level standard for content comprises:
defining a range of acceptable sound measurements in relation to said average sound level of said baseline sound measurement.

4. The method of claim 1, wherein said setting a baseline sound measurement comprises:
setting a baseline sound measurement comprising a peak sound level.

5. The method of claim 4, wherein said defining a sound level standard comprises:
defining a range of acceptable sound measurements in relation to said peak sound level.

6. The method of claim 1, wherein said providing notification further comprises:
sending said notification to a remotely located command center.

7. The method of claim 1, wherein said providing notification further comprises:
sending said notification to said party, wherein said party is not in control of a volume control of said sound system.

8. The method of claim 1, further comprising:
storing information related to said determining if said live sound measurement complies with said sound level standard for content.

9. The method of claim 1, wherein said defining a sound level standard for content comprises:
defining said sound level standard in relation to said live content.

10. The method of claim 9, wherein said live content comprises an advertisement.

11. The method of claim 1, wherein said live content and said baseline sample signal each comprises pink noise.

12. The method of claim 1, wherein
performing c-weighting filtering when setting said baseline sound measurement; and
providing c-weighting filtering when determining said live sound measurement.

13. A system for compliance, comprising:
a sound system located in an auditorium, wherein said sound system comprises audio speakers;
a multi-media player capable of being controlled by a third party content provider, wherein said multi-media player stores a baseline sample signal and first content, wherein said multi-media player broadcasts said baseline sample signal through said sound system at a first predetermined time for a baseline period, and broadcasts said first content at a second predetermined time through said sound system;
an audio receiver located in said auditorium, wherein said audio receiver receives said baseline sample signal and said first content that are broadcasted through said sound system;
a baseline sound measurement module for setting a baseline sound measurement for said audio receiver that is based on said baseline sample signal received at said audio receiver;
a sound level standard applicable to content being played in auditoriums;
a sound measurement module for determining a live sound measurement taken over a live sampling period of said first content broadcast from said sound system;
a comparator for determining if said live sound measurement complies with said sound level standard;
a notification module for providing notification of non-compliance with said sound level standard to a party sourcing said second content.

14. The system of claim 13, further comprising:
a central controller associated with said party for receiving from a plurality of notifying modules over a communication network a plurality of notifications of compliance and non-compliance with said sound level standard applicable to a plurality of auditoriums.

15. The system of claim 13, wherein said first content comprises advertising content.

16. The system of claim 13, wherein said first content comprises alternative content.

17. The system of claim 13, wherein said baseline sample signal comprises pink noise.

18. The system of claim 13, further comprising:
a c-weighting filter for filtering said baseline sample signal and said first content received at said audio receiver.

19. The system of claim 13, wherein said sound level standard is defined in relation to said first content.

20. A system for compliance, comprising:
a first sound system of audio speakers located in a first auditorium;
a first audio receiver located in said first auditorium;
a second sound system of audio speakers located in a second auditorium, wherein said second sound system comprises audio speakers;
a second audio receiver located in said second auditorium;
a first baseline sample signal broadcast over said first sound system during a first baseline period;
a second baseline sample signal broadcast over said second sound system during a second baseline period;
first content broadcast over said first sound system;
second content broadcast over said second sound system;
a sound level standard applicable to content being broadcast in auditoriums in general;
a first customized sound level standard that comprises said sound level standard adjusted in relation to said first baseline sound measurement;
a second customized sound level standard that comprises said sound level standard adjusted in relation to said second baseline sound measurement;
a first live sound measurement taken over a first live sampling period of said first content broadcast from said first sound system;
a second live sound measurement taken over a second live sampling period of said second content broadcast from said second sound system;
a first comparator for determining if said first live sound measurement complies with said first customized sound level standard;
a second comparator for determining if said second live sound measurement complies with said second sound level standard;
a central controller for receiving a first notification of compliance or non-compliance with said first customized sound level standard, and for receiving a second notification of compliance or non-compliance with said second customized sound level standard.

21. The system of claim 20, wherein said first auditorium and said second auditorium are located in a theater

22. The system of claim 20, wherein said first auditorium is located in a first theater and said second auditorium is located in a second theater.

23. The system of claim 20, wherein said first and second baseline sample signals each comprises pink noise.
